(19) United States
(12) Patent Application Publication
(10) Pub. No.: US 2006/0219512 A1
(43) Pub. Date: Oct. 5, 2006

(54) Electromagnetic clutch

(75) Inventors: Tomonori Matsumura, Isesaki-shi (JP); Hirokazu Ichinose, Isesaki-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Sanden Corporation, Isesaki-shi (JP)

(21) Appl. No.: 11/392,619

(22) Filed: Mar. 30, 2006

(30) Foreign Application Priority Data
Mar. 30, 2005 (JP) 2005-098310

(51) Int. Cl. F16D 27/112

(52) U.S. Cl. 192/70.18; 192/84.91

(57) ABSTRACT

In this electromagnetic clutch, only each of the plate springs is connected to the second rotor by first connecting members. Therefore, each of the first holes of the plate springs is accurately positioned to the position of each of the second holes of the extended portion. That is, it is not necessary to provide a useless gap between the first connecting members and the each of the holes. Also, the extended portion of the second rotor is opposed to the armature plate in the axial direction. Therefore, the inner diameter of the armature plate can be formed small irrespective of the extended portion.

### BACKGROUND OF THE INVENTION

(i) Field of the Invention

The present invention relates to an electromagnetic clutch for transmitting power from a power source of a vehicle to a compressor of an air conditioner for vehicle, for example.

(ii) Description of the Related Art

A generally known electromagnetic clutch includes a first rotor rotating by power from outside, an armature plate arranged oppositely to the first rotor in the axial direction and having one end face capable of being brought into contact with the first rotor, an electromagnetic coil for attracting the armature plate to the first rotor side, a second rotor having its outer circumferential face formed oppositely to an inner circumferential face of the armature plate in the radial direction and rotating with a driven shaft of a driven device, a plurality of plate springs arranged between the armature plate and the second rotor, a plurality of first rivets for connecting one end side of each of the plate springs to an outer circumference portion of the second rotor from the direction opposite to the first rotor, a plurality of second rivets for connecting the other end side of each of the plate springs to the other end face of the armature plate, and a stopper plate fixed to the second rotor together with the one end side of each of the plate springs by the first rivet, said stopper plate arranged oppositely to the other end face of the armature plate with a predetermined interval in the axial direction, and said stopper plate which is capable of regulating movement of the armature plate to the other end face side of the armature plate.

In the above electromagnetic clutch, a plurality of first holes to which each of the first rivets is inserted are provided on the second rotor, a plurality of second holes to which each of the first rivets is inserted are provided on the stopper plate, and a third hole to which each of the first rivets is inserted is provided on the one end side of each of the plate springs. When each of the rivets is inserted to the first hole, the second hole and the third hole and each of the rivets is caulked, the electromagnetic clutch is assembled.

However, there is a possibility that displacement might be generated in each of the first holes by machining in a tolerance. There is also a possibility that displacement might be generated in each of the second holes by machining in a tolerance. Therefore, it is necessary to provide a gap considering the tolerance between the inner circumferential faces of the first hole and the second hole and the outer circumferential face of the first rivet. To this end, during the time from insertion of the first rivets into the first hole, the second hole and the third hole to caulking of the first rivets, the second rotor, the armature plate and each of the plate springs are capable of mutual movement in the error range. That is, each of the plate springs might be displaced with respect to the second rotor.

Also, in the above electromagnetic clutch, when the armature plate is attracted to the first rotor by the electromagnetic coil, the power from the outside is transmitted to a rotational axis of the driven device. Therefore, if an attraction area between the armature plate and the first rotor becomes large, an allowable torque which can be transmitted to the rotational axis of the driven device is increased.

However, the outer circumferential face of the second rotor is opposed to the inner circumferential face of the armature plate in the radial direction. Also, the outer diameter of the second rotor can not be made small due to the need to mount each of the plate springs. Therefore, the inner diameter of the armature plate can not be reduced to enlarge the attraction area. Also, enlargement of the outer diameter of the armature plate or reinforcement of a magnetic force of the electromagnetic coil results in increase in size and power consumption of the electromagnetic clutch.

### SUMMARY OF THE INVENTION

An object of the present invention is to provide an electromagnetic clutch which can reduce displacement between a second rotor and a plate spring due to assembling and enlarge an attraction area by reducing the inner diameter of an armature plate.

In order to achieve the above object, an electromagnetic clutch for transmitting a turning force of a first rotor rotated by power from outside to a rotational axis of a driven device is provided with an armature plate arranged oppositely to the first rotor in the axial direction, and the armature plate in which one end face is capable of contacting with first rotor, an electromagnetic coil for attracting the armature plate to the first rotor side, a second rotor which has an opposite face arranged oppositely with the other end face of the armature plate with a predetermined interval in the axial direction, and the second rotor which is capable of rotating together with the rotational axis of the driven device, a plate spring arranged between the armature plate and the second rotor, and the plate spring for transmitting the turning force from the armature plate to the second rotor, a first connecting member for connecting one end side of the plate spring to the opposite face of the second rotor, and a second connecting member for connecting the other end side of the plate spring to the armature plate.

By this, the opposite face of the second rotor is opposed to the other end face of the armature plate with a predetermined interval in the axial direction. Therefore, there is no need to fix another part to the second rotor by the first connecting member in order to regulate movement of the armature plate to the other end face side of the armature plate. That is, the first connecting member fixes only the plate spring to the second rotor. Thus, there is no need to provide a useless gap between the inner circumferential face of a hole provided on the second rotor to insert the first connecting member and the outer circumferential face of the first connecting member. That is, displacement between the second rotor and the plate spring due to assembling can be reduced. Also, the opposite face of the second rotor is opposed to the other end face of the armature plate with a predetermined interval in the axial direction. Therefore, even if the inner diameter of the armature plate is formed small, the armature plate does not interfere with the second rotor. Thus, the attraction area between the armature plate and the first rotor can be enlarged by reducing the inner diameter of the armature plate. That is, the allowable torque which can be transmitted to the rotational axis of the driven device can be increased without enlargement of the outer diameter of the armature plate or reinforcement of the magnetic force of the electromagnetic coil.

The above and other objects, features, and advantages of the present invention will become more apparent from the following description and the accompanying drawings.

### BRIEF DESCRIPTION OF THE DRAWINGS

FIG. 1 is a front view of an electromagnetic clutch showing an embodiment of the present invention;

FIG. 2 is a sectional view of A-A line in FIG. 1;

FIG. 3 is a side sectional view before assembling of an armature plate, a second rotor and each of plate springs;

FIG. 4 is a side sectional view showing the state where the armature plate with a small inner diameter, the second rotor and each of the plate springs are assembled;

FIG. 5 is a front view of an electromagnetic clutch showing a variation of a plate spring;

FIG. 6 is a sectional view of B-B line in FIG. 5;

FIG. 7 is a front view of an electromagnetic clutch showing a first variation of an extended portion;

FIG. 8 is a front view of an electromagnetic clutch showing a second variation of an extended portion;

FIG. 9 is a front view of an electromagnetic clutch showing a third variation of an extended portion; and

FIG. 10 is a front view of an electromagnetic clutch showing a fourth variation of an extended portion.

### DESCRIPTION OF THE PREFERRED EMBODIMENTS

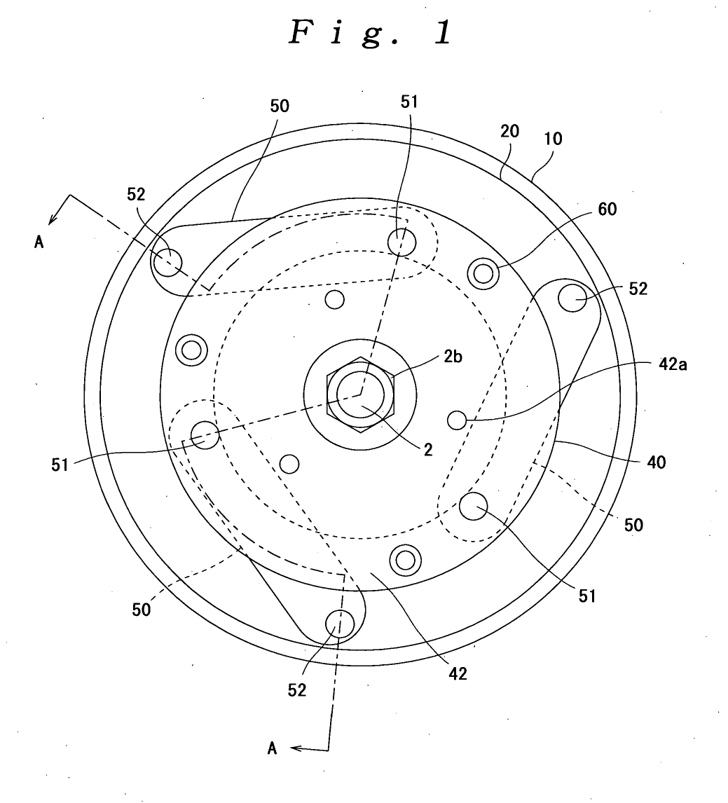

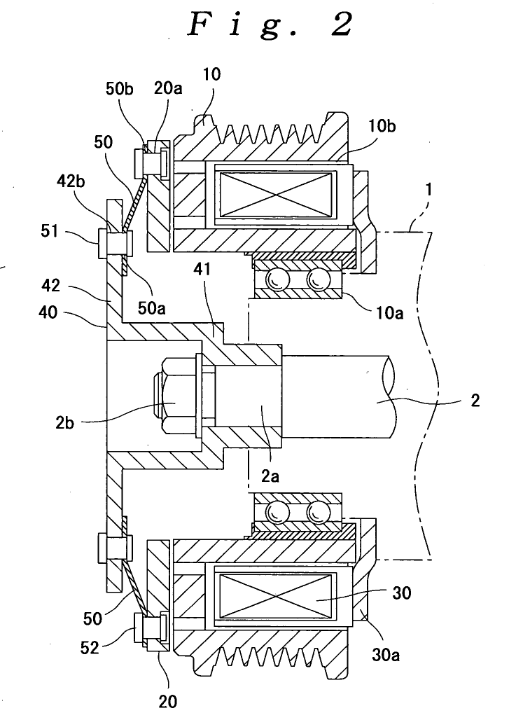

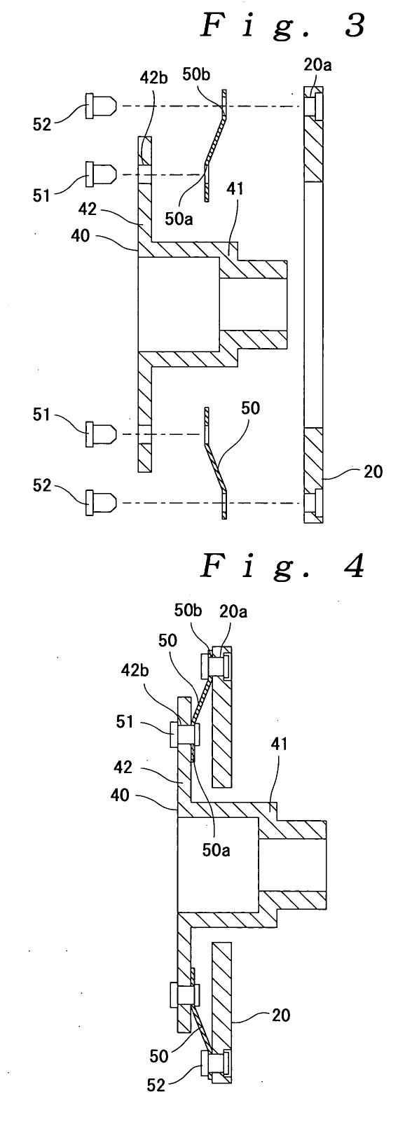

FIGS. 1 to 4 show an embodiment of the present invention. FIG. 1 is a front view of an electromagnetic clutch showing an embodiment of the present invention, FIG. 2 is a sectional view of A-A line in FIG. 1, FIG. 3 is a side sectional view before assembling of an armature plate, a second rotor and each of plate springs, and FIG. 4 is a side sectional view showing the state where the armature plate with a small inner diameter, the second rotor and each of the plate springs are assembled.

An electromagnetic clutch of this embodiment is provided with a first rotor 10 to which power from an engine, not shown, is transmitted, an armature plate 20 arranged oppositely to the first rotor 10 in the axial direction and having one end face capable of being brought into contact with the first rotor 10, an electromagnetic coil 30 for attracting the armature plate 20 to the first rotor 10 side, a second rotor 40 having an extended portion 42 provided oppositely to the other end face of the armature plate 20 with a predetermined interval in the axial direction and connected to a rotational axis 2 of a compressor 1, and a plurality of plate springs 50 provided between the armature plate 20 and the second rotor 40.

The first rotor 10 is a known pulley with an outer circumferential face around which a V-belt, not shown, can be wound, and the first rotor 10 is rotatably supported by the compressor 1 through a bearing 10a. An annular groove portion 10b is provided on the first rotor 10, and the groove portion 10b is provided on the end face of the first rotor 10 on the compressor 1 side. Within the groove portion 10b, the electromagnetic coil 30 is arranged.

The armature plate 20 is made of a steel material and has a disk shape.

A predetermined gap is provided between the electromagnetic coil 30 and the groove portion 10b of the first rotor 10. The electromagnetic coil 30 is mounted on the compressor 1 through a mounting plate 30a.

The second rotor 40 has a cylindrical connecting portion 41 for connecting to the rotational axis 2 of the compressor 1 and the extended portion 42 formed integrally with the connecting portion 41 and extending outward in the radial direction from the end of the connecting portion 41 on the side opposite to the first rotor 10.

The inner circumferential face of the connecting member 41 is engaged with a spline 2a provided at the tip end side of the rotational axis 2 in the rotating direction. The connecting portion 41 is fixed to the rotational axis 2 by a nut 2b screwed with the tip end of the rotational axis 2.

The extended portion 42 is in the disk state and is opposed to the other end face of the armature plate 20 with a predetermined interval in the axial direction. Also, a plurality of rubber vibration isolators 60 are provided on the extended portion 42, and each of the rubber vibration isolators 60 is arranged with an interval to each other in the circumferential direction of the extended portion 42. A plurality of holes 42a are provided on the extended portion 42, and each of the holes 42a is arranged with an interval to each other in the circumferential direction of the extended portion 42. A jig, not shown, is attached to each of the holes 42a when attaching/removing the second rotor 40 to/from the rotational axis 2.

Each of the plate springs 50 is made of spring steel and arranged with an interval to each other in the circumferential direction of the first rotor 10. One end side of each of the plate springs 50 is connected to the second rotor 40 by a first connecting member 51, while the other end side of each of the plate springs 50 is connected to the armature plate 20 by a second connecting member 52. In more detail, to the one end side of each of the plate springs 50 is provided a first hole 50a. A plurality of second holes 42b are provided on the extended portion 42 of the second rotor 40, and each of the second holes 42b is provided with an interval to each other in the circumferential direction of the extended portion 42. Each of the first connecting members 51 is inserted into each of the holes 50a and 42b. On the other end side of each of the plate springs 50 is provided a third hole 50b. A plurality of fourth holes 20a are provided on the armature plate 20, and each of the fourth holes 20a is provided with an interval in the circumferential direction of the armature plate 20. Into each of the holes 50b and 20a is inserted the second connecting member 52. Each of the connecting members 51 and 52 is made of a known rivet. Each of the plate springs 50 is arranged slantingly by a predetermined angle in the rotating direction of the armature plate 20. By this, when the electromagnetic clutch transmits the turning force to the rotational axis 2, a force in the compressing direction is applied to each of the plate springs 50.

In the above electromagnetic clutch, the armature plate 20, the second rotor 40 and the plate springs 50 are assembled as shown in FIG. 3. That is, each of the first connecting members 51 is inserted into each of the holes 50a and 42b, and each of the second connecting members 52 is inserted into each of the holes 50b and 20a. Also, each of the first connecting members 51 is caulked after insertion into each of the holes 50a and 42b, and each of the second connecting members 52 is caulked after insertion into each of the holes 50b and 20a. The first connecting member 51 after caulking does not protrude to the first rotor 10 side from the other end face of the armature plate 20.

In this way, only the plate springs 50 is connected to the second rotor 40 by the first connecting members 51. By this, when each of the plate springs 50 is aligned to the second rotor 40, the position of each of the first holes 50a can be surely aligned to the position of each of the second holes 42b. Therefore, the outer diameter of the first connecting member 51 can be formed in the size equivalent to the inner diameter of each of the holes 50a and 42b. That is, it is not necessary to provide a useless gap between the outer circumferential face of the first connecting member 51 and the inner circumferential face of each of the holes 50a and 42b.

Also, if each of the plate springs 50 is accurately positioned with respect to the second rotor 40, each of the third holes 50b and each of the fourth holes 20a can be surely positioned. Therefore, the outer diameter of the second connecting member 52 can be formed in the size equivalent to the inner diameter of each of the holes 50b and 20a. That is, it is not necessary to provide a useless gap between the outer circumferential face of the second connecting member 52 and the inner circumferential face of each of the holes 50b and 20a.

Also, in order to surely connect the armature plate 20, the second rotor 40 and each of the plate springs 50 to each other, each of the connecting members 51 and 52 is caulked till its outer circumferential face is brought into contact with the inner circumferential face of each of the holes 50a, 42b, 50b and 20a. As mentioned above, it is not necessary to provide a useless gap between the outer circumferential face of each of the connecting members 51 and 52 and the inner circumferential face of each of the holes 50a, 42b, 50b and 20a. Therefore, a load to caulk each of the connecting members 51 and 52 can be made small.

In the electromagnetic clutch assembled as above, when a predetermined current flows through the electromagnetic coil 30, the armature plate 20 is attracted to the first rotor 10 against an urging force of each of the plate springs 50. When the armature plate 20 is attracted to the first-rotor 10, the first rotor 10 and the armature plate 20 are rotated together. By this, the turning force is transmitted from the armature 20 to the second rotor 40 via each of the plate springs 50. That is, the rotational axis 2 of the compressor 1 is rotated.

In this case, if an attraction area between the armature plate 20 and the first rotor 10 is enlarged, an allowable torque which can be transmitted to the rotational axis 2 can be increased. On the other hand, the extended portion 42 of the second rotor 40 is formed oppositely to the other end face of the armature plate 20 with a predetermined interval in the axial direction. Therefore, the inner diameter of the armature plate 20 can be formed small irrespective of the outer diameter of the extended portion 42. Also, the caulked first connecting member 51 does not protrude to the first rotor 10 side from the other end face of the armature plate 20. Therefore, the inner diameter of the armature plate 20 can be formed small irrespective of the position of each of the first connecting members 51.

In this way, in the electromagnetic clutch in this preferred embodiment, only each of the plate springs 50 is connected to the second rotor 40 by each of the first connecting members 51. Therefore, the outer diameter of each of the first connecting members 51 can be formed in the size equivalent to the inner diameter of each of the holes 50a and 42b. That is because, if each of the plate springs 50 is positioned respectively with respect to the second rotor 40, the position of each of the first holes 50a can be surely aligned to the position of each of the second holes 42b. Each of the holes 50a and 42b is provided on each of the plate springs 50 and the second rotor 40. Therefore, each of the first connecting members 51 is surely inserted into each of the holes 50a and 42b. That is, it is not necessary to provide a useless gap between the outer circumferential face of each of the first connecting members 51 and the inner circumferential face of each of the holes 50a and 42b. By this, displacement due to assembling of the second rotor 40 and each of the plate springs 50 can be reduced.

Also, if each of the plate springs 50 is accurately positioned with respect to the second rotor 40, each of the third holes 50b and each of the fourth holes 20a can be surely positioned. By this, the outer diameter of the second connecting member 52 and the inner diameter of each of the holes 50 band 20 a can be formed in the equivalent size. Therefore, it is not necessary to provide a useless gap between the outer circumferential face of each of the second connecting members 52 and the inner circumferential face of each of the holes 50b. That is, displacement due to assembling of each of the plate springs 50 and the armature plate 20 can be reduced.

Moreover, it is not necessary to provide a useless gap between the outer circumferential face of the first connecting member 51 and the inner circumferential face of each of the holes 50a and 42b. Therefore, a load to caulk each of the first connecting members 51 can be made small. By this, a large force is not applied to the second rotor 40 and each of the plate springs 50 when caulking each of the first connecting members 51, and deformation of the second rotor 40 and each of the plate springs 50 can be prevented.

Also, since it is not necessary to provide a useless gap between the outer circumferential face of the second connecting member 52 and the inner circumferential face of each of the holes 50b and 20a, a load to caulk each of the second connecting members 52 can be made small. By this, a large force is not applied to the armature plate 20 and each of the plate springs 50 when caulking each of the second connecting members 52, and deformation of the armature plate 20 and each of the plate springs 50 can be prevented.

Moreover, the extended portion 42 of the second rotor 40 is opposed to the other end face of the armature plate 20 with a predetermined interval in the axial direction. Therefore, the inner diameter of the armature plate 20 can be formed small irrespective of the outer diameter of the extended portion 42. By this, the attraction area can be enlarged by reducing the inner diameter of the armature plate 20, (See FIG. 4). That is, the allowable torque which can be transmitted to the rotational axis 2 can be increased without enlarging the outer diameter of the armature plate 20 or reinforcing the attracting force of the electromagnetic coil 30.

Also, each of the caulked first connecting members 51 does not protrude to the first rotor 10 side from the other end face of the armature plate 20. Therefore, the inner diameter of the armature plate 20 can be formed small irrespective of the position of each of the first connecting members 51. That is, it is extremely advantageous in enlarging the attraction area by reducing the inner diameter of the armature plate 20.

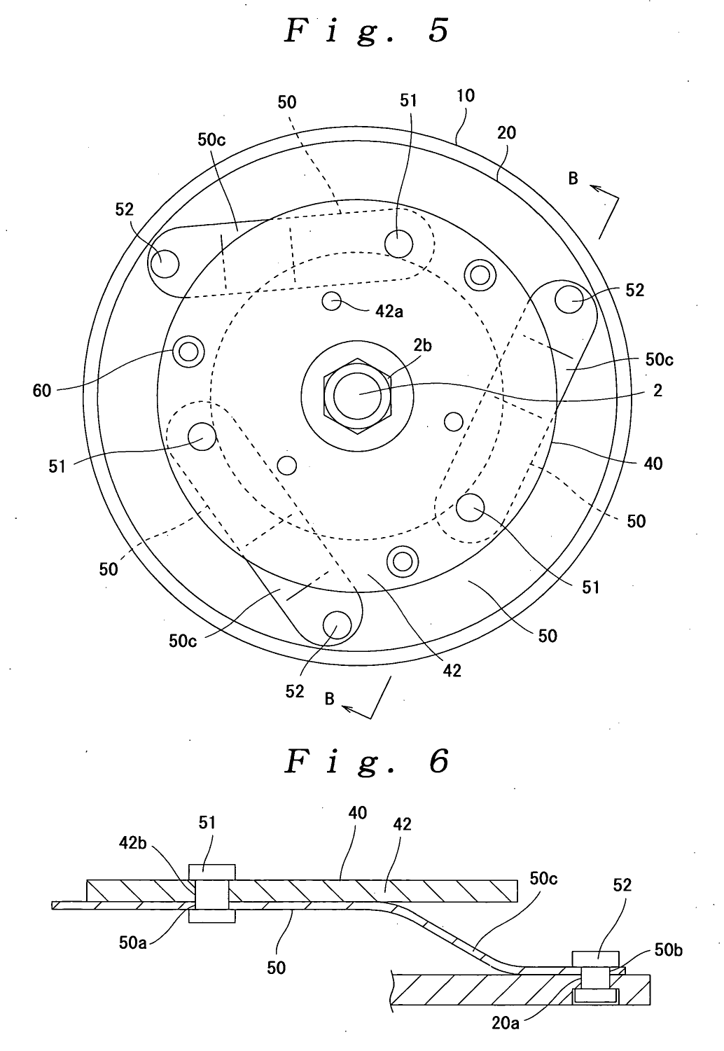

Also, each of the caulked first connecting members 51 does not protrude to the first rotor 10 side from the other end face of the armature plate 20. Therefore, the first connecting member 51 can be arranged outside in the radial direction from the inner diameter of the armature plate 20. Thus, a setting range of an inclination angle of each of the plate springs 50 in the rotating direction is widened. That is, an inclined portion 50c is provided between one end and the other end of each of the plate springs 50, and the inclined portion 50c is formed so that it is inclined to the first rotor 10 side. When a part of the force in the compressing direction applied to the plate spring 50 acts as a pressing force for pressing the armature plate 20 to the first rotor 10 side, the adjustment range of the pressing force can be widened (See FIGS. 5 and 6).

In this embodiment, each of the plate springs 50 is arranged so that it is inclined by a predetermined angle in the rotating direction. By this, a force in the compressing direction is applied to each of the plate springs 50 when transmitting a turning force to the rotational axis 2. On the contrary, a flat plate spring may be arranged so that it is inclined by a predetermined angle in the direction opposite to the rotating direction. Here, the plate spring does not have a portion inclined to the first rotor 10 side.

Also, in this embodiment, the armature plate 20 and the second rotor 40, and each of the plate springs 50 are connected by each of the connecting members 51 and 52. On the contrary, a known bolt or other fastening members maybe used instead of each of the connecting members 51 and 52.

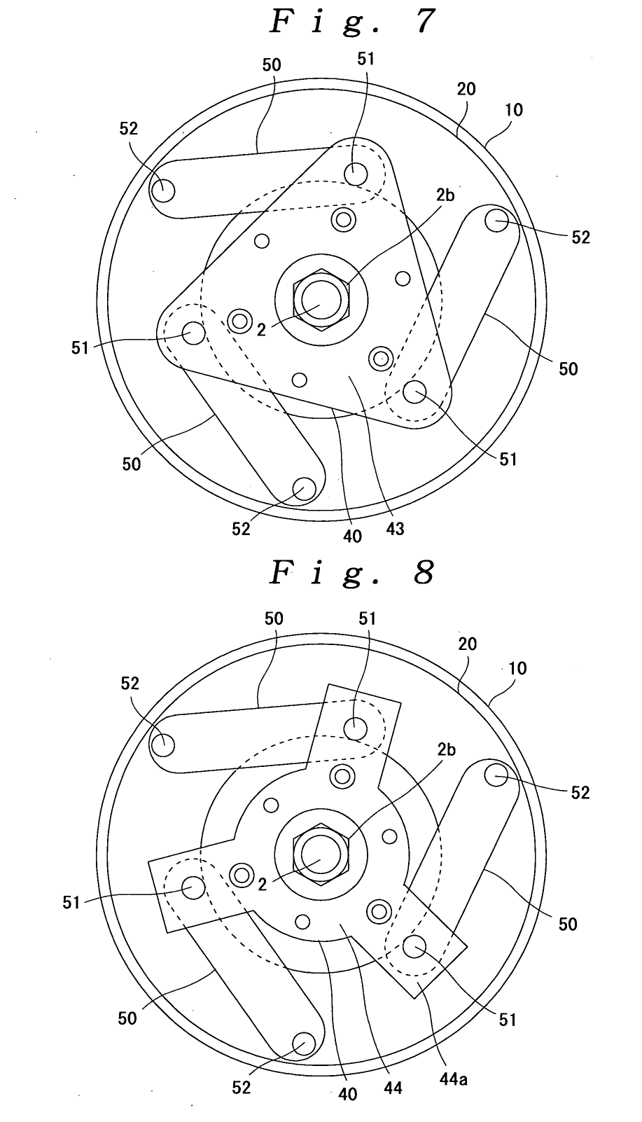

In this embodiment, the extended portion 42 of the second rotor 40 is formed in the disk state. On the contrary, it is possible to form an extended portion 43 almost in the triangular plate and to connect the vicinity of its vertex to one end side of each of the plate springs 50 (See FIG. 7). By this, a weight can be reduced as compared with the disk-state extended portion 42. That is, it is extremely advantageous in reducing the weight of the electromagnetic clutch.

Also, it is possible to form an extended portion 44 in the disk state smaller than the extended portion 42 and to provide a plurality of projection portions 44a on its outer circumferential portion (See FIG. 8). Each of the projection portions 44a is provided with an interval to each other in the circumferential direction of the extended portion 44. One end side of each of the plate springs 50 is connected to each of the projection portions 44a. By this, a weight can be reduced as compared with the simply disk-state extended portion 42. That is, it is extremely advantageous in reducing the weight of the electromagnetic clutch.

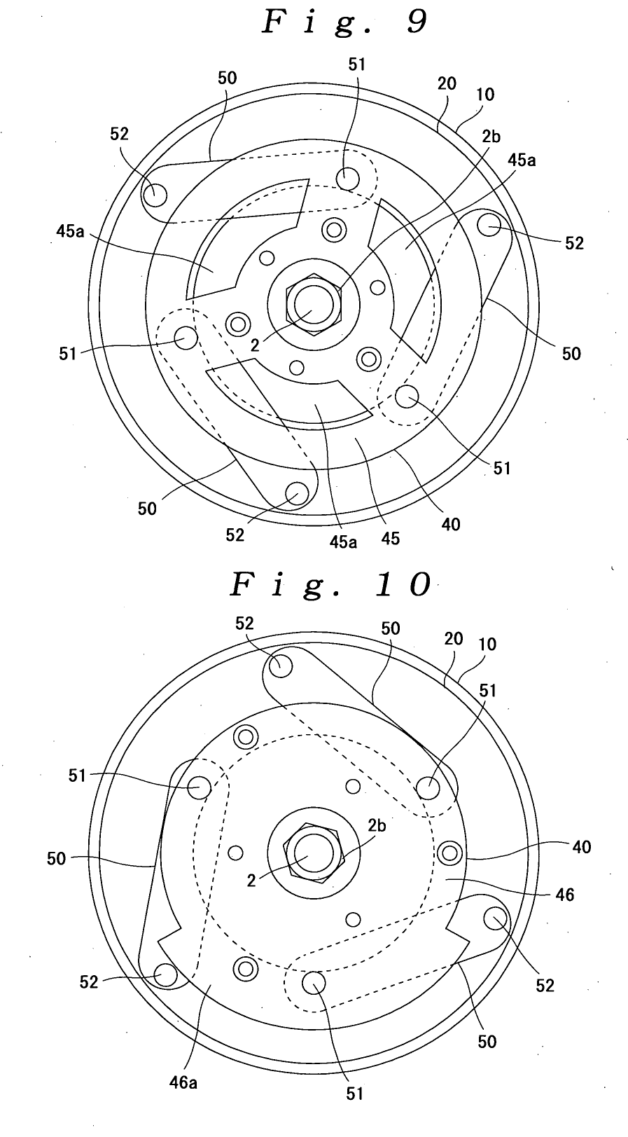

Moreover, it is possible to form an extended portion 45 in the disk state and to provide a plurality of lightning parts 45a on a part thereof (See FIG. 9). By this, a weight can be reduced as compared with the simply disk-state extended portion 42. That is, it is extremely advantageous in reducing the weight of the electromagnetic clutch.

Also, it is possible to form an extended portion 46 in the disk state and to provide a counter weight 46a at a predetermined position in the circumferential direction of the outer circumferential portion of the extended portion 46 (See FIG. 10). The counter weight 46a protrudes outward in the radial direction from the outer circumferential portion of the extended portion 46. By this, an unbalanced weight within the compressor 1 can be reduced without separately providing a counter weight. That is, it is extremely advantageous in reducing the manufacturing costs.

The preferred embodiments described in this specification are illustrative and not restrictive. The scope of invention is given by the appended claims, and all changes and modifications included in the meaning of claims are embraced in the present invention.

What is claimed is:

1. An electromagnetic clutch for transmitting a turning force of a first rotor rotated by a power from outside to a rotational axis of a driven device, the electromagnetic clutch comprising:
an armature plate arranged oppositely to the first rotor in the axial direction, and the armature plate in which one end face is capable of contacting with first rotor;
an electromagnetic coil for attracting the armature plate to the first rotor side;
a second rotor which has an opposite face arranged oppositely with the other end face of the armature plate with a predetermined interval in the axial direction, and the second rotor which is capable of rotating together with the rotational axis of the driven device;
a plate spring arranged between the armature plate and the second rotor, and the plate spring for transmitting the turning force from the armature plate to the second rotor;
a first connecting member for connecting one end side of the plate spring to the opposite face of the second rotor; and
a second connecting member for connecting the other end side of the plate spring to the armature plate.

2. The electromagnetic clutch according to claim 1, wherein
the first connecting member does not protrude to the first rotor side from the other end face of the armature plate.

3. The electromagnetic clutch according to claim 1, wherein
the second rotor has:
a connection portion for connecting with the rotational axis of the driven device; and
an extended portion provided extending outward in the radial direction from the connection portion, and the extended portion formed in the polygonal plate state, and the extended portion arranged oppositely to the other end face of the armature plate in the axial direction, and
the first connecting member connects one end side of the plate spring to the vicinity of a vertex of the polygon of the extended portion.

4. The electromagnetic clutch according to claim 1, wherein
the second rotor has:
a connection portion for connecting with the rotational axis of the driven device;
an extended portion provided extending outward in the radial direction from the connection portion, the extended portion arranged oppositely to the other end face of the armature plate in the axial direction; and
a plurality of projection portions provided extending outward in the radial direction from the outer circumferential portion of the extended portion, and the projection portions arranged with an interval to each other in the circumferential direction of the second rotor, and
the first connecting member connects one end side of the plate spring to the projection portion.

5. The electromagnetic clutch according to claim 3, wherein
a lightning part is provided on the extended portion.

6. The electromagnetic clutch according to claim 4, wherein
a lightning part is provided on the extended portion.

7. The electromagnetic clutch according to claim 3, wherein
a counter weight is integrally provided at a predetermined position in the circumferential direction on the extended portion.

8. The electromagnetic clutch according to claim 4, wherein
a counter weight is integrally provided at a predetermined position in the circumferential direction on the extended portion.
